(19) United States
(12) Patent Application Publication
(10) Pub. No.: US 2009/0206291 A1
(43) Pub. Date: Aug. 20, 2009

(54) GAS FLOW RATE CONTROL VALVE

(75) Inventors: Chin-Ying Huang, Taichung (TW); Hsin-Ming Huang, Taichung (TW); Chung-Sheng Yen, Taichung County (TW)

Correspondence Address: BROWDY AND NEIMARK, P.L.L.C.;624 NINTH STREET, NW, SUITE 300, WASHINGTON, DC, 20001-5303, US

(73) Assignee: Grand Mate Co. Ltd., Taichung (TW)

(21) Appl. No.: 12/204,112

(22) Filed: Sep. 4, 2008

(30) Foreign Application Priority Data
Feb. 20, 2008 (TW) 97105957

(51) Int. Cl. F16K 31/06

(52) U.S. Cl. 251/129.15; 251/129.2

(57) ABSTRACT

A gas flow rate control valve includes a lower valve block defining a gas flow passage, and an upper valve block having a tube disposed ill communication with the gas flow passage, and a solenoid coil assembly surrounding the tube for generating a magnetic field. A magnetic column has a magnetic portion inserted into the tube and axially movable by the magnetic field generated by the solenoid coil assembly, and a stopper movable with the magnetic portion to change the open cross-sectional area of the gas flow passage so as to control the flow rate of the fuel gas passing through the gas flow passage. A spring member is provided at one of the top and bottom sides of the magnetic column to keep the magnetic column in balance and to provide a return force to the magnetic column after displacement of the magnetic column.

### BACKGROUND OF THE INVENTION

1. Field of the Invention

The present invention relates generally to gas equipments and more particularly, to a gas flow rate control valve for controlling the flow rate of a fuel gas accurately.

2. Description of the Related Art

Taiwan patent publication number M322516 discloses a gas flow rate control valve. According to this design, the gas flow rate control valve comprises a rotary gas supply control disk and a fixed gas supply control disk. The rotary gas supply control disk has multiple gas flow rate control holes that have different diameters. The fixed gas supply control disk has a guide hole. By means of selectively setting one gas flow rate control hole of the rotary gas supply control disk into communication with the guide hole of the fixed gas supply control disk, the fuel gas is allowed to pass through the gas flow rate control valve. By means of selectively shifting the gas flow rate control holes of the rotary gas supply control disk into communication with the guide hole of the fixed gas supply control disk, the gas flow rate is relatively regulated.

According to the aforesaid prior art design, the gas flow rate control is limited to the design of the gas flow rate control holes, i.e., the gas flow rate control holes allow regulation of the gas flow rate step by step, however they do not allow for linear gas flow rate control. This inconvenient gas flow rate control method cannot satisfy user's different demands. Further, when rotating the rotary gas supply control disk to regulate the gas flow rate, the supply of the fuel gas may be interrupted before alignment of the next gas flow rate control hole with the guide hole, resulting in flame failure. Therefore, this design of gas flow rate control valve is not safe in use.

Therefore, it is desirable to provide a gas flow rate control valve that eliminates the aforesaid problems.

### SUMMARY OF THE INVENTION

The present invention has been accomplished under the circumstances in view. It is the main objective of the present invention to provide a gas flow rate control valve, which directly controls adjustment of the open cross-sectional area of the gas flow passage subject to the amount of displacement of a magnetic column, achieving accurate gas flow rate control.

It is another objective of the present invention to provide a gas flow rate control valve, which has a simple structure that works positively.

To achieve these objectives of the present invention, the gas flow rate control valve comprises: a lower valve block, which defines a gas flow passage for the passing of a fuel gas, an upper valve block, which is fixedly mounted on a top side of the lower valve block and includes a tube disposed in communication with the gas flow passage, and a solenoid coil assembly surrounding the tube for generating a magnetic field, a magnetic column, which includes a magnetic portion inserted into the tube and axially movable in the tube by the magnetic field generated by the solenoid coil assembly, and a stopper movable with the magnetic portion to change an open cross-sectional area of the gas flow passage so as to further control a flow rate of the fuel gas passing through the gas flow passage, and a spring member provided at one of top and bottom sides of the magnetic column to keep the magnetic column in balance and to provide a return force to the magnetic column after a displacement of the magnetic column.

By means of controlling the solenoid coil assembly to generate a magnetic field and to further control the amount of displacement of the magnetic column, the open cross-sectional area of the gas flow passage is relatively adjusted, achieving accurate gas flow rate control. The linear relationship between the magnetic field generated by the solenoid coil assembly and the amount of displacement of the magnetic column assures accurate gas flow rate control. Further, the gas flow rate control valve has simple structure and positive working characteristics.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given herein below and the accompanying drawings which are given by way of illustration only, and thus are not limitative of the present invention, and wherein:

FIG. 1 is an exploded view of a gas flow rate control valve in accordance with a first embodiment of the present invention;

FIG. 2 is a sectional assembly view of the gas flow rate control valve in accordance with the first embodiment of the present invention;

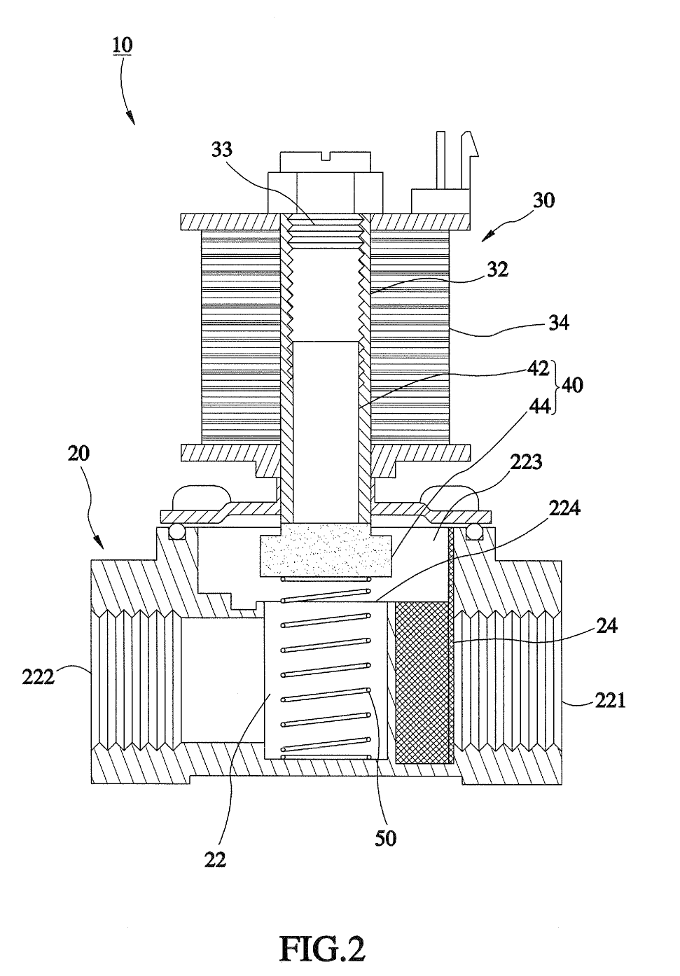

FIG. 3 is similar to FIG. 2 but showing the magnetic column moved;

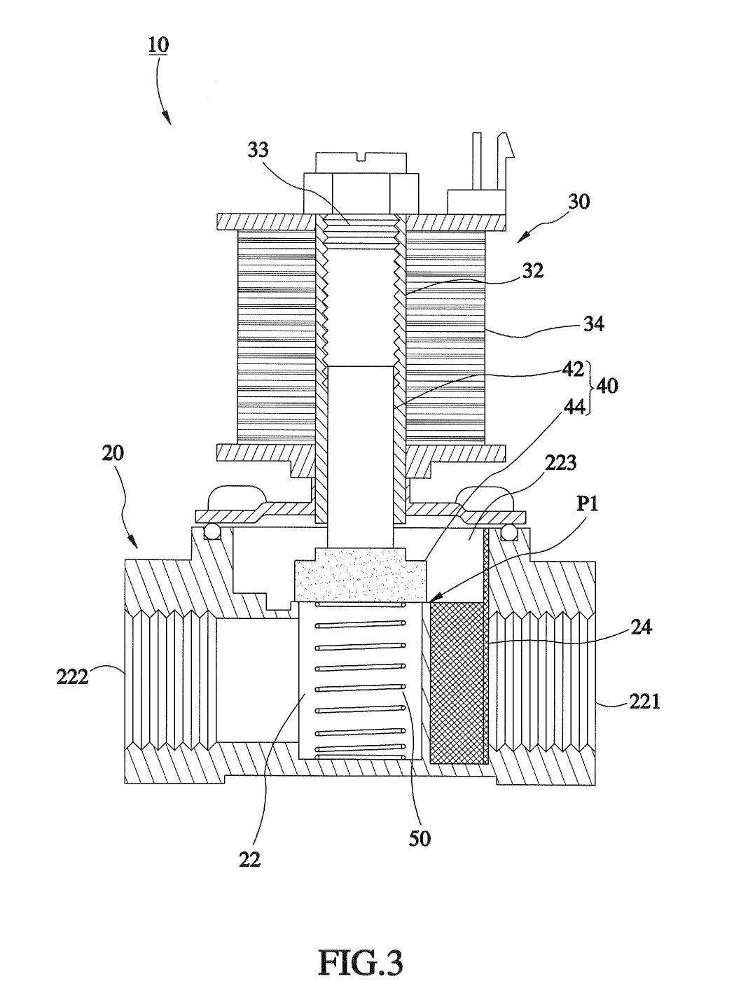

FIG. 4 is a sectional assembly view of a gas flow rate control valve in accordance with a second embodiment of the present invention;

FIG. 5 is similar to FIG. 4 but showing the magnetic column moved;

FIG. 6 is a sectional assembly view of the gas flow rate control valve in accordance with a third embodiment of the present invention, and

FIG. 7 is similar to FIG. 6 but showing the magnetic column moved.

### DETAILED DESCRIPTION OF THE INVENTION

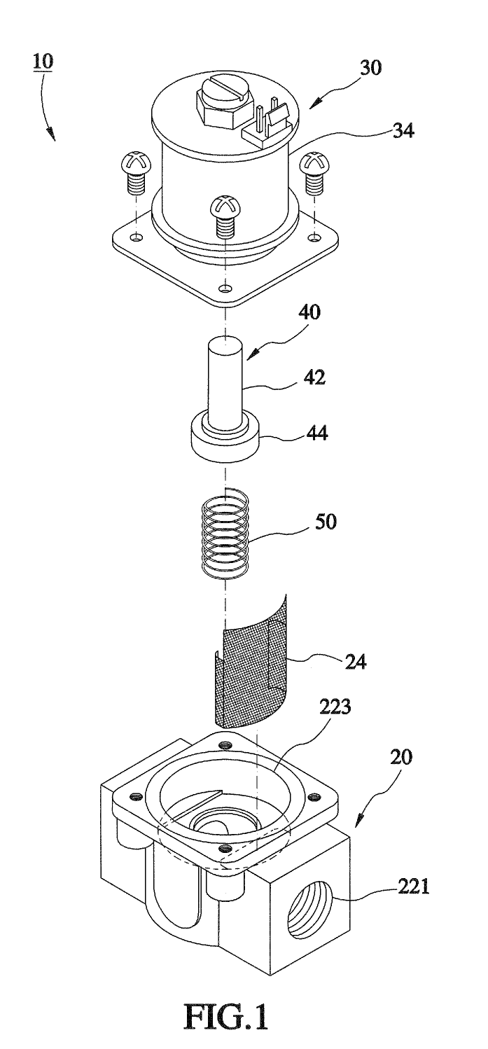

Referring to FIG. 1, a gas flow rate control valve 10 in accordance with a first embodiment of the present invention is shown comprised of a lower valve block 20, an upper valve block 30, a magnetic column 40, and a spring member 50.

The lower valve block 20 comprises a gas flow passage 22 for the passing of a fuel gas. The gas flow passage 22 comprises a gas inlet 221, a gas outlet 222, a communication hole 224 between the gas inlet 221 and the gas outlet 222, and an opening 223 located above the communication hole 224. The inlet 221 is for letting the fuel gas go into the inside of the lower valve block 20. The outlet 221 is for letting the fuel gas to out of the lower valve block 20. The opening 223 is in communication with a middle part of the passage 22 and located at the top side of the lower valve block 20. Normally, the fuel gas flows through the gas inlet 221 to the opening 223 and then flows through the communication hole 224 and then the as outlet 222 to the outside of the lower valve block 20. The lower valve block 20 further comprises a filter gauze 24 mounted in the middle part of the gas flow passage 22 between the gas inlet 221 and the gas outlet 223 to remove solid matters from the fuel gas passing through the lower valve block 20.

The upper valve block 30 comprises a tube 32, a seal 33, and a solenoid coil assembly 34 surrounding the tube 32. The upper valve block 30 is fixedly fastened to the top side of the lower valve block 20 to block the opening 223. The tube 32 is kept in communication with the opening 223 of the gas flow passage 22 and located above and aligned with the communication hole 224 for accommodating the magnetic column 40. The seal 33 seals the top side of the tube 32 to prevent gas leakage. The solenoid coil assembly 34 surrounds the tube 32. When electrically conducted, the solenoid coil assembly 34 will generate a magnetic field to move the magnetic column 40. When the electric current to the solenoid coil assembly 34 is increased, the intensity of the magnetic field generated by the solenoid coil assembly 34 will become stronger, i.e., the attractive force produced by the solenoid coil assembly 34 to move the magnetic column 40 will become greater. Further, changing the direction of the current inputted to the solenoid coil assembly 34 causes change of the polarity of the magnetic field, and the direction of the force applied to the magnetic column 40 is reversed.

The magnetic column 40 comprises a magnetic portion 42 and a stopper 44. The magnetic portion 42 is formed of a permanent magnet. The stopper 44 is made of rubber and affixed to the bottom side of the magnetic portion 42. The magnetic portion 42 is inserted into the tube 32 within the working range of the solenoid coil assembly 34. Therefore, the magnetic portion 42 can be moved up and down in the tube 32. Because two reversed polarities (S pole and N pole) are produced at two opposite sides relative to the reference line at the center of the solenoid coil assembly 34 when the solenoid coil assembly 34 is electrically conducted, the top side of the magnetic portion 42 is normally kept at the elevation below the center of the solenoid coil assembly 34 for enabling the polarity at the top side of the magnetic column 40 to be driven by the solenoid coil assembly 34. Subject to the effect of the magnetic field of the solenoid coil assembly 34 acted upon the magnetic portion 42, the magnetic column 40 is moved axially along the tube 32. During displacement of the magnetic column 40 along the tube 32, the stopper 44 relatively changes the open ratio of the communication hole 224 of the gas flow passage 22, thereby regulating the flow rate of the fuel gas passing through the communication hole 224. When the magnetic column 40 is moved to a close position P1, the stopper 44 blocks the entire gas flow passage 22, and the fuel gas is prohibited from passing through the lower valve block 20.

The spring member 50 is a compression spring that can be mounted on one of the top and bottom sides of the magnetic column 40. According to this embodiment, the spring member 50 is provided at the bottom side of the magnetic column 40, so that the gas flow rate control valve 10 is a normal open valve. The spring member 50 extends in the axial direction of the magnetic column 40 to keep the magnetic column 40 in balance and to provide a return force to the magnetic column 40 after each displacement of the magnetic column 40.

Based on the aforesaid structure, the solenoid coil assembly 34 does not generate any magnetic field when it is not electrically conducted; the stopper 44 of the magnetic column 40 is lifted by the spring member 50 for allowing the fuel gas to pass through the gas flow passage 22 of the lower valve block 20, and the top side of the magnetic portion 42 is normally kept below the elevation of the center of the solenoid coil assembly 34. When electric current goes through the solenoid coil assembly 34, the solenoid coil assembly 34 generates a magnetic field. If the polarity at the bottom side of the solenoid coil assembly 34 is same as the polarity at the top side of the magnetic portion 42 of the magnetic column 40, the magnetic portion 42 of the magnetic column 40 will be forced downwards by the magnetic repulsive force. At this time, the ratio of the open cross-sectional area of the communication hole 224. is relatively reduced, and therefore the flow rate of the fuel gas is relatively reduced. When the user regulates the amount of the electric current passing through the solenoid coil assembly 34 through an operating interface, the intensity of the magnetic filed generated by the solenoid coil assembly 34 will be relatively adjusted, and the magnetic portion 42 will be moved subject to the intensity of the magnetic field, achieving accurate gas flow rate control. When the magnetic force generated by the solenoid coil assembly 34 surpasses the spring force of the spring member 50, the magnetic portion 42 is forced downwards to the close position P1 to block the gas flow passage 22 of the lower valve block 20, stopping the fuel gas from passing through the lower valve block 20.

Further, the cooperation between the spring member 50 and the permanent magnet of the magnetic portion 42 has another effect. For easy understanding of this effect, we hereinafter explain the relation of axial force balance between the spring member 50 and the permanent magnet of the magnetic column 40 as follows:

ΣF=0 Fₘ−KX=0→Fₘ=KX

Fm: Magnetic force of the solenoid coil assembly 34 acted upon the magnetic portion 42;

K: Spring constant of the spring member 50;

X: Amount of displacement of the magnetic column 40.

Based on the aforesaid structure, inputting an electric current to the gas flow rate control valve 10 causes the solenoid coil assembly 34 to generate a magnetic field that controls the amount of displacement of the magnetic column 40, thereby adjusting the open cross sectional area of the communication hole 224 of the gas flow passage 22 (the greater the X value is the smaller the open cross-sectional area will be), and therefore the desired gas flow rate control is achieved. Further, the magnetic portion 42 according to this embodiment is formed of a permanent magnet to have a small magnetic hysteresis. Therefore, there is a certain relationship between the value of the input current and the generated magnetic force, i.e., the rise curve and the decline curve are approximately equal in the input current-magnetic column 40 displacement relationship diagram. According to test, when an input current of a certain value causes an increase of a displacement and a reverse input current of the same value causes a decrease of a displacement, the error therebetween is below 3-5%. Therefore, the gas flow rate control valve 10 of the present invention has an accurate gas flow rate control characteristic. Further, when compared to conventional designs, the invention has simple structure and accurate action characteristics.

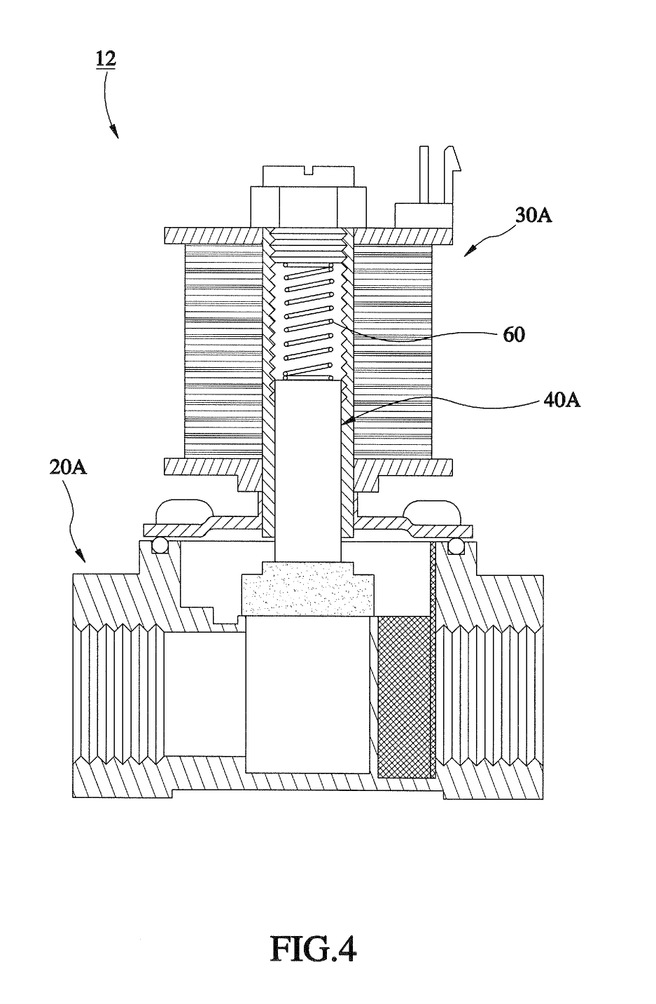

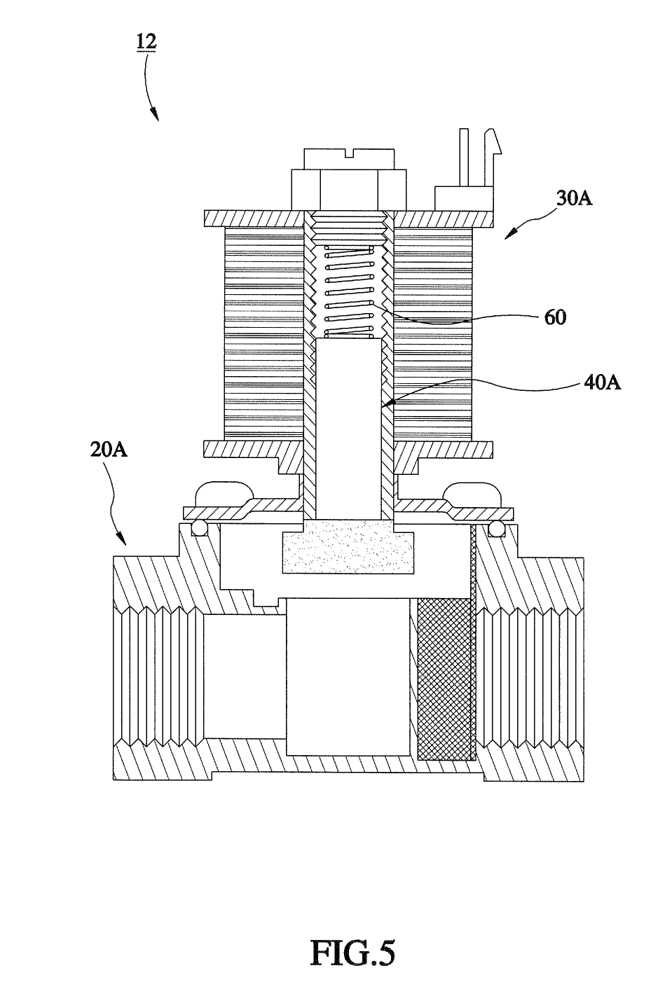

FIGS. 4 and 5 show a gas flow rate control valve 12 in accordance with a second embodiment of the present invention. Similar to the aforesaid first embodiment, the gas flow rate control valve 12 is comprised of a lower valve block 20A, an upper valve block 30A, a magnetic column 40A, and a spring member 60. According to this second embodiment, the spring member 60 is a compression spring provided at the top side of the magnetic column 40A. The gas flow rate control valve 12 is a normal close valve. The spring member 60 extends in the axial direction of the magnetic column 40A to keep the magnetic column 40A in balance and to provide a return force to the magnetic column 40A after each displacement of the magnetic column 40A.

Based on the aforesaid arrangement, the working direction of the magnetic column 40A is reversed to that of the aforesaid first embodiment. Therefore, this second embodiment achieves the same effects as the aforesaid first embodiment.

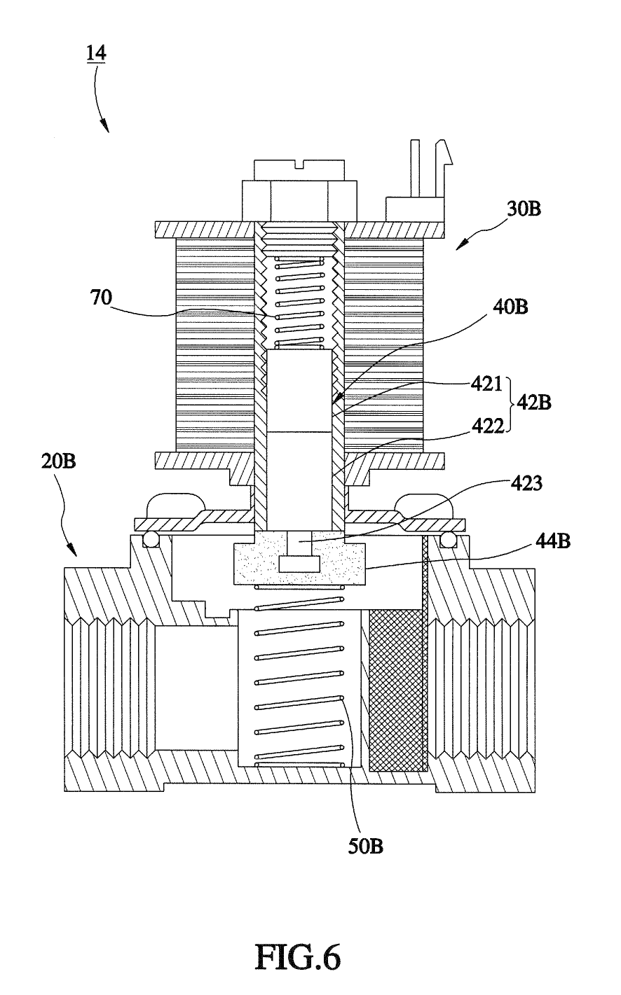

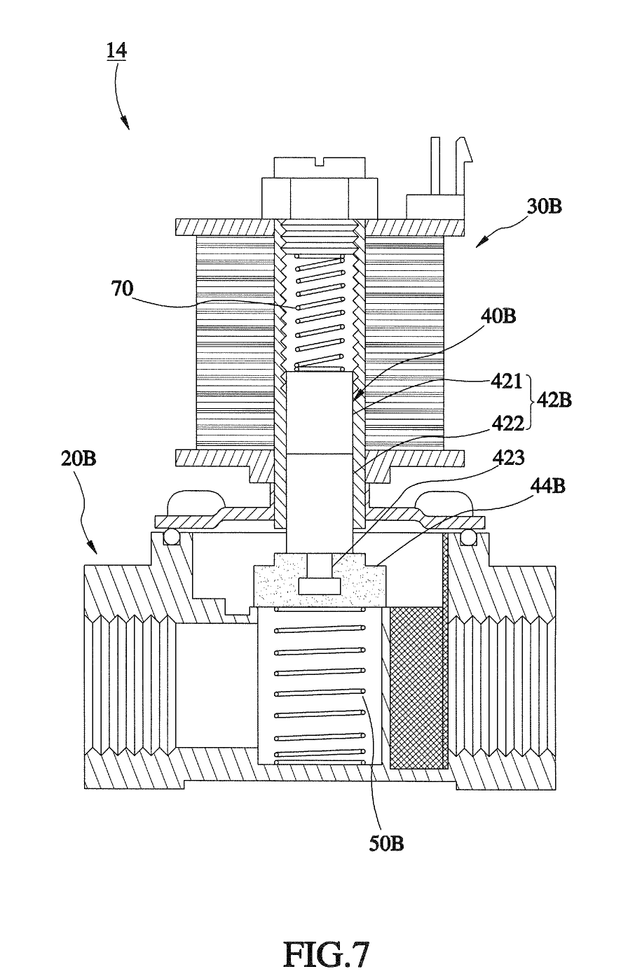

FIGS. 6 and 7 show a gas flow rate control valve 14 in accordance with a third embodiment of the present invention. Similar to the aforesaid first embodiment, the gas flow rate control valve 14 is comprised of a lower valve block 20B, an upper valve block 30B, a magnetic column 40B, and a spring member 50B. According to this embodiment, the magnetic portion 42B of the magnetic column 40B is comprised of a permanent magnet 421 and a magnetically conductive block 422, and the stopper 44B of the magnetic column 40B is a rubber member capped on the bottom side of the magnetically conductive block 422. This embodiment shows a different configuration of the magnetic column 40A. The magnetically conductive block 422 is made of a ferrous material, having a bottom mounting bolt 423 for securing the rubber stopper 44B. However, the design of the bottom mounting bolt 423 is not a limitation. The gas flow rate control valve 14 further comprises a supplementary spring member 70. The supplementary spring member 70 and the spring member 50B are respectively provided at the two opposite sides of the magnetic column 40B. According to this embodiment, the spring member 50B is provided at the bottom side of the magnetic column 40B, and the gas flow rate control valve 14 is a normal open valve; the supplementary spring member 70 is provided at the top side of the magnetic column 40B; the supplementary spring member 70 and the spring member 50B work in reversed directions, providing a force to move the magnetic column 40B. Further, the force of the supplementary spring member 70 is smaller than the force of the spring member 50B.

Subject to the aforesaid arrangement, the supplementary spring member 70 assists the gas flow rate control valve 14 in regulating the force relative to the magnetic column 50B so that the control of the gas flow rate control valve 14 is close to a linear control, assuring accurate control of the gas flow rate. Therefore, this third embodiment achieves the same effects as the aforesaid first and second embodiments.

It is to be understood that the top side of the magnetic portion 42 according to the first embodiment is normally disposed below the elevation of the center of the solenoid coil assembly 34, assuring the magnetic pole at the top side of the magnetic column 40 to be positively driven by the solenoid coil assembly 34; on the contrary, the bottom side of the magnetic portion 42 can be normally disposed above the elevation of the center of the solenoid coil assembly 34, assuring the magnetic pole at the bottom side of the magnetic column 40 to be positively driven by the solenoid coil assembly 34.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A gas flow rate control valve comprising:
a lower valve block having a gas flow passage for the passing of a fuel gas;
an upper valve block fixedly mounted on a top side of the lower valve block, the upper valve block including a tube disposed in communication with the gas flow passage, and a solenoid coil assembly surrounding the tube for generating a magnetic field when the solenoid coil assembly is electrically conducted;
a magnetic column having a magnetic portion inserted into the tube and axially movable in the tube by the magnetic field generated by the solenoid coil assembly, the magnetic portion is comprised of a permanent magnet, and a stopper movable with the magnetic portion to change an open cross-sectional area of the gas flow passage so as to control a flow rate of the fuel gas passing through the gas flow passage; and
a spring member provided at one of top and bottom sides of the magnetic column and extending in an axial direction of the magnetic column to keep the magnetic column in balance and to provide a return force to the magnetic column.

2. The gas flow rate control valve as claimed in claim 1, wherein the magnetic portion further comprises a magnetically conductive block.

3. The gas flow rate control valve as claimed in claim 1, wherein the magnetic portion has a top side normally disposed below an elevation of a center of the solenoid coil assembly.

4. The gas flow rate control valve as claimed in claim 1, wherein the lower valve block further comprises a filter gauze mounted in the gas flow passage.

5. The gas flow rate control valve as claimed in claim 1, wherein the spring member is a compression spring provided at the bottom side of the magnetic column, such that the gas flow rate control valve is in a normal open manner.

6. The gas flow rate control valve as claimed in claim 1, wherein the spring member is a compression spring provided at the top side of the magnetic column, such that the gas flow rate control valve is in a normal close manner.

7. The gas flow rate control valve as claimed in claim 1, further comprising a supplementary spring member provided at one of the top and bottom sides of the magnetic column opposite to the spring member; the supplementary spring member and the spring member work in reversed directions against each other.

8. The gas flow rate control valve as claimed in claim 7, wherein the supplementary spring member has a spring force smaller than that of the spring member.

9. The gas flow rate control valve as claimed in claim 1, wherein the magnetic portion has a bottom side normally disposed above an elevation of a center of the solenoid coil assembly.
